(19) United States
(12) Patent Application Publication
(10) Pub. No.: US 2022/0194534 A1
(43) Pub. Date: Jun. 23, 2022

(54) COMPOSITION FOR A WETSUIT

(71) Applicant: Eco-Pivot LLC, Los Angeles, CA (US)

(72) Inventor: Mark Price, Solana Beach, CA (US)

(21) Appl. No.: 17/556,699

(22) Filed: Dec. 20, 2021

Related U.S. Application Data
(60) Provisional application No. 63/127,969, filed on Dec. 18, 2020.

(51) Int. Cl. B63C 11/04; B32B 25/12; B32B 25/10; B32B 5/02; B32B 5/18; B32B 5/24

(52) U.S. Cl. CPC B63C 11/04; B32B 25/12; B32B 25/10; B32B 5/026; B32B 5/18; B32B 5/245; B32B 2437/00; B32B 2266/0207; B32B 2250/03; B32B 2262/0253; B32B 2266/08; B32B 2307/304; B63C 2011/046

(57) ABSTRACT

A wetsuit comprising a Yulex® foam layer, further includes a jersey layer of polypropylene (PP) fiber that is adhered to the Yulex foam layer, either on an outer surface (i.e. away from a wearer's body) or an inner surface (i.e. close to a wearer's skin), or both. A wetsuit disclosed herein can further include an inner lining of a synthetic or natural textile, which may or may not be patterned, and which can be adhered directly to the Yulex foam layer or to the PP jersey layer.

### CROSS-REFERENCES TO RELATED APPLICATIONS

This application claims the benefit of U.S. Provisional Application No. 63/127,969, entitled “COMPOSITION FOR A WETSUIT”, and filed Dec. 18, 2020, the entirety of which is incorporated by reference herein.

### BACKGROUND

A wetsuit is a garment that is made of a thermally-insulative, elastic material for water sports such as surfing, diving, swimming, and other water-based activities. The overwhelming majority of conventional wetsuits are made with neoprene foam, over which an elastic jersey, typically formed of nylon, is adhered. The jersey can be adhered to one or both of the inner surface and outer surface of the neoprene foam.

Nylon® is a brand name for a thermoplastic polymer, and designates a group of synthetic polymers that are formed from aliphatic or semi-aromatic polyamides. A nylon jersey, found in most wetsuits today, is formed of nylon fibers that are knitted to a specific elasticity, which typically is consistent with the elasticity of the thermally-insulative neoprene layer. While nylon is fairly resilient, a nylon jersey tends to break down, dry out, and lose elasticity or stretchiness after repeated use and/or exposure to the elements, such as salt water, wind and sun.

Neoprene® is a brand name that designates a family of synthetic rubbers and foam based on petroleum-based, chloroprene polymers. In wetsuit applications, Neoprene is provided as a closed-cell foam that allows a small amount of water to pass onto the wearer's skin, where that water is heated by the wearer's body temperature to provide further thermal insulation. The closed-cell Neoprene foam does not all heat to escape too readily. However, many people are allergic to Neoprene, and can experience an allergic reaction to the chloroprene or to other substances which are used in the processing and manufacture of Neoprene foam sheets. For instance, during the vulcanization process of polychloroprene, a substance called ethylene thiourea (ETU) is often used as an accelerant for deriving a closed-cell foam from polychloroprene plastic. ETU is found to be toxic, and is often not fully removed from or eliminated from the produced Neoprene.

Some conventional wetsuits include further insulation in the form of a liner, such as a synthetic textile fiber like polyester or nylon, or blend thereof. Alternatively, natural materials such as wool fiber have been used. Many of these insulating wetsuit linings are textured, and sometimes formed with patterns, which can make long-term adherence to the Neoprene foam challenging. Further, these linings are fairly inelastic, and therefore can only be positioned on an inner surface of the Neoprene that does not move too much when worn or used.

### SUMMARY

To solve the aforementioned problems and limitations of conventional wetsuits, a wetsuit comprising a Yulex® foam layer is described. A jersey layer of polypropylene (PP) fiber is adhered to the Yulex foam layer, either on an outer surface (i.e. away from a wearer's body) or an inner surface (i.e. close to a wearer's skin), or both. A wetsuit disclosed herein can further include an inner lining of a synthetic or natural textile, which may or may not be patterned, and which can be adhered directly to the Yulex foam layer or to the PP jersey layer.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIGS. 1A-1C are cross section of a wetsuit formed of materials described herein.

Like reference symbols in the various drawings indicate like elements.

### DETAILED DESCRIPTION

This document describes a wetsuit that improves upon, and solves problems with, conventional wetsuits and the materials from which they are made. In some preferred implementations, a wetsuit includes a Yulex® foam layer for thermal insulation. The wetsuit further includes one or two jersey layers, formed of polypropylene (PP) fiber, that are adhered to the Yulex foam layer, either on an outer surface (i.e. away from a wearer's body) or an inner surface (i.e. close to a wearer's skin), or both. In some implementations, a wetsuit can further include an inner lining of a synthetic or natural textile, which may or may not be patterned, and which can be adhered directly to the Yulex foam layer or to the PP jersey layer.

Yulex® is a brand name for a bio-based, polymerized rubber produced from the Guayule plant, that produces an open or closed-cell, ultra-pure thermoset elastomeric foam. In a wetsuit application, Yulex has been mixed with common petroleum-based thermoplastics to yield a closed cell foam of 20-50 percent Yulex. In some implementations of the current subject matter, however, a thermal insulation foam is formed of 80-99 percent Yulex. In these implementations, the higher concentration of Yulex is more environmentally-friendly and more comfortable to the wearer than conventional Neoprene. Further, at higher concentrations of Yulex, a thermal foam can be recycled, or can be disposed of without the toxicity or environmental damage as Neoprene.

A Yulex-based foam layer as described herein can be cut to size and/or contoured to any number of shapes for covering a wearer's body, using any of a number of known techniques, tooling, equipment or processes. Further, due to Yulex foam's improved thermal insulation characteristics that are better than Neoprene, a wetsuit made of the materials described herein can be less thick, more resilient, more elastic, better fitting, and longer-lasting than traditional wetsuits formed of a Neoprene foam layer with Nylon jersey.

PP fiber is nonhygroscopic, and can be formed into a jersey with suitable stretchability. A jersey formed of PP fiber is also bacteria-resistant or even completely anti-bacterial, and therefore more hygienic, which is especially important if a wearer does not often rinse or clean their wetsuit. PP fiber has low heat resistance, and accordingly does not yield to wrinkling as easily as Nylon. In some implementations, a PP jersey includes a knit fabric that includes a weft knit textile in which PP multifilament yarn and an elastic yarn are knit in plating fashion, so as to be adhered or laminated onto a Yulex foam layer. A suitable adhesive or laminating process can be used.

The knitting in plating fashion can be thermally fused with an elastic yarn by heat-setting at 80° to 160° C. In preferred implementations, the PP multifilament yarn can be formed of a yarn that is formed, and then stretched to an elongation of 1.4 to 2.5 times, where the PP multifilament yarn has up to 50 filaments to correspond to 15 to 60 decitex, and a thickness of around 1 decitex. The thickness of the PP jersey can be modified so as to optimize adherence to the Yulex foam layer.

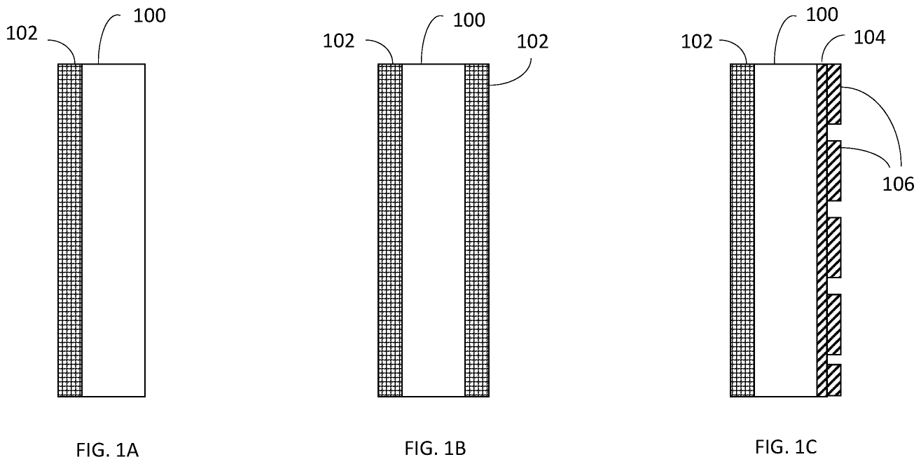

FIGS. 1A-1C show various implementations of a wetsuit material formed of various combinations of a PP multifilament jersey material and a Yulex-based elastomeric closed cell foam. With reference to FIG. 1A, a Yulex foam layer 100 is provided. The foam layer 100 can have a thickness of 1 mm to 5 mm, depending on the application, such as temperature of the water in which the wear will be active. The wetsuit material further includes a PP multifilament layer 102 that is adhered to an inner or outer surface of the Yulex foam layer 100. The adherence can include heat welding, gluing, sewing, fastening, or otherwise attach the PP multifilament layer 102 to the Yulex foam layer 100. In some implementations, the PP multifilament layer 102 can include woven fibers of an elastic material, for a desired lateral elasticity that matches or is otherwise consistent with an elasticity of the Yulex foam layer 100, which will prevent separation or delamination.

In some implementations, a PP multifilament layer 102 can be adhered to both an inner and an outer surface of the Yulex foam layer 100, as shown in FIG. 1B. In yet other implementations, a liner 104 can be provided and adhered on a portion of an inner surface of the Yulex foam layer 100 (i.e. a surface facing the wearer's body), while the PP multifilament layer 102 is adhered to an outer surface of the Yulex foam layer 100, as shown in FIG. 1C. In some implementations, the liner 104 is formed of a natural material such as wool, or a synthetic material such as polyester or nylon bristles or microfibers. The liner 104 can be placed only in some selected areas of the inner surface of the wetsuit material or wetsuit, such as a torso region, a midsection region, thigh regions, or a back region. Other regions are possible. These regions might experience less movement by a corresponding region of the wearer's body.

The liner 104 may include a pattern 106 of the liner material, so as to create more areas for trapping air and/or water, and for additional thermal insulation. The liner 104 may or may not be adhered to at least some part of the PP multifilament layer 102. The liner 104 can be glued, sewn, or otherwise affixed to either the PP multifilament layer 102 and/or the Yulex foam layer 100.

Although a few embodiments have been described in detail above, other modifications are possible. Other embodiments may be within the scope of the following claims.

1. A wetsuit for being worn by a person, the wetsuit comprising:
a plurality of sheets of wetsuit material, the plurality of sheets being cut for a particular body part of the person and bonded together in the form of the wetsuit, at least one of the plurality of sheets comprising:
a thermal insulation layer formed of 80-99 percent plant-based natural rubber; and
a first jersey layer adhered directly to the thermal insulation layer on a surface of the thermal insulation layer opposite the person when worn by the person, the first jersey layer being formed of a material that includes polypropylene fiber.

2. The wetsuit in accordance with claim 1, further comprising a second jersey layer adhered directly to the thermal insulation layer on a surface of the thermal insulation layer toward the person when worn by the person, the second jersey layer being formed of polypropylene fiber.

3. The wetsuit in accordance with claim 1, wherein the plant-based natural rubber is a closed-cell, thermoset elastomeric foam produced from Guayule plant material.

4. The wetsuit in accordance with claim 1, wherein the first jersey layer includes elastic yarn that is combined with polypropylene multifilament yarn as a weft knit textile that is knitted in plating fashion.

5. The wetsuit in accordance with claim 4, wherein the polypropylene multifilament yarn has up to 50 filaments to correspond to 15 to 60 decitex.
